(19) United States
(12) Patent Application Publication
(10) Pub. No.: US 2025/0147581 A1
(43) Pub. Date: May 8, 2025

(54) FIT GUIDANCE

(71) Applicant: Apple Inc., Cupertino, CA (US)

(72) Inventors: Paul X. WANG, Cupertino, CA (US); Adam Y. KOLLGAARD, Santa Clara, CA (US); Scott M. LEINWEBER, Sunnyvale, CA (US); Venkata Narayana Murthy ARELEKATTI, Palo Alto, CA (US); John CAGLE, Cupertino, CA (US); Liam R. MARTINEZ, Sunnyvale, CA (US); Ivan S. MARIC, San Francisco, CA (US); Stephen E. DEY, San Francisco, CA (US); Trevor J. NESS, Santa Cruz, CA (US); Sally R. ANNIS, Santa Cruz, CA (US); Jeremy C. FRANKLIN, San Francisco, CA (US)

(21) Appl. No.: 18/691,030

(22) PCT Filed: Sep. 12, 2022
(86) PCT No.: PCT/US2022/043257

§ 371 Date: Mar. 11, 2024

Related U.S. Application Data
(60) Provisional application No. 63/247,228, filed on Sep. 22, 2021.

(51) Int. Cl. G06F 3/01; G01L 5/00; G02B 27/00; G02B 27/01

(52) U.S. Cl. CPC G06F 3/013; G01L 5/0028; G02B 27/0093; G02B 27/0101; G02B 27/017; G02B 27/0179; G02B 2027/0138; G02B 2027/0181

(57) ABSTRACT

A wearable electronic device can include interface features to provide guidance for optimal placement of the wearable electronic device. The wearable electronic device and/or another electronic device can be operated to guide a user to position the wearable electronic device in a manner that will achieve proper alignment of components with respect to the user and maximize user comfort. For example, the wearable electronic device and/or another device can include sensors for detecting features of the user's face, forces distributed on the face when worn, and/or alignment with the face (e.g., eyes). The guidance can include instructions or other interface features to encourage adjustment of the wearable electronic device. While the head wearable electronic device can provide such guidance to the user wearing it, the feedback can also be provided to another person and/or via another device.

### CROSS-REFERENCE TO RELATED APPLICATION

This application claims the benefit of U.S. Provisional Application No. 63/247,228, entitled “FIT GUIDANCE FOR HEAD-MOUNTABLE DEVICES,” filed Sep. 22, 2021, the entirety of which is incorporated herein by reference.

### TECHNICAL FIELD

The present description relates generally to head-mountable devices, and, more particularly, to fit guidance for head-mountable devices.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include speaker output and/or haptic feedback. A user may further interact with the head-mountable device by providing inputs for processing by one or more components of the head-mountable device. For example, the user can provide tactile inputs, voice commands, and other inputs while the device is mounted to the user's head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a top view of a head-mountable device, according to some embodiments of the present disclosure.

FIG. 2 illustrates a side view of an electronic device in use to measure distances to different face regions of a user, according to some embodiments of the present disclosure.

FIG. 3 illustrates a rear view of a head-mountable device, according to some embodiments of the present disclosure.

FIG. 4 illustrates a flow chart for a process having operations performed by a head-mountable device and/or an electronic device, according to some embodiments of the present disclosure.

FIG. 5 illustrates a side view of a head-mountable device in use by a user, according to some embodiments of the present disclosure.

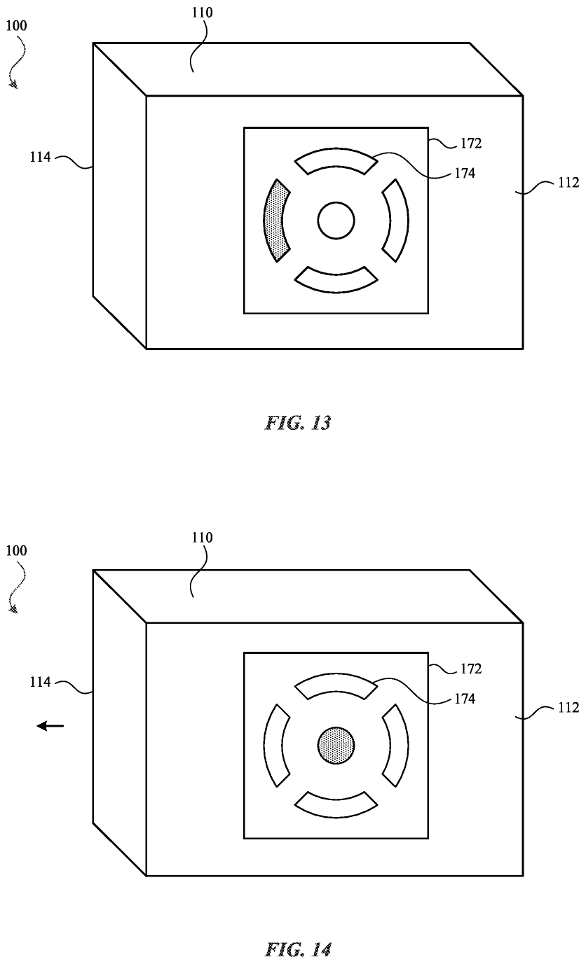

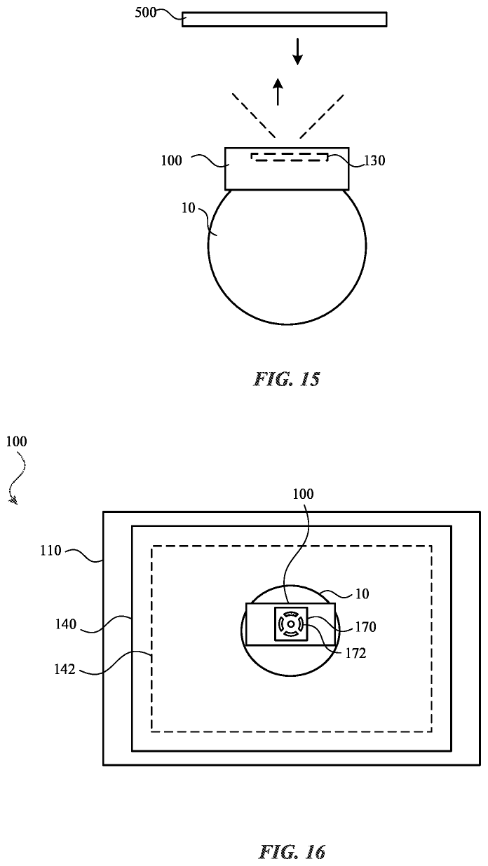

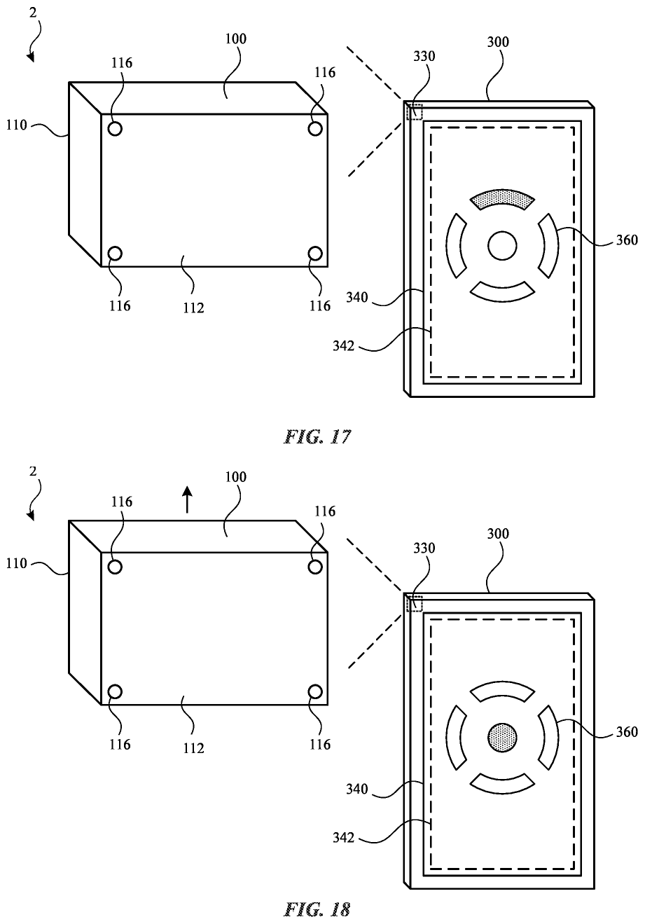

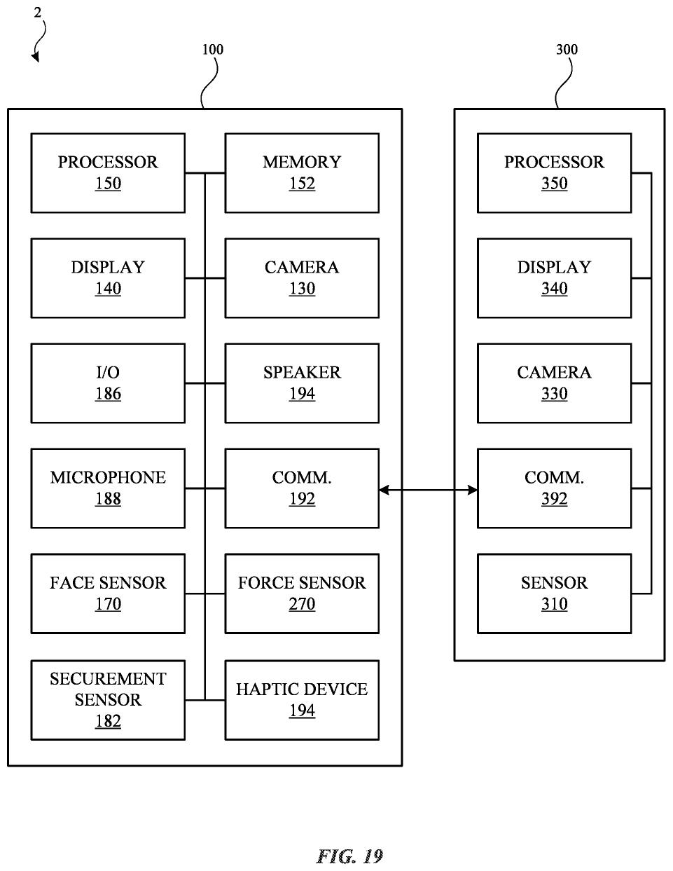

FIG. 4 illustrates a side view of the head-mountable device of FIG. 5 in an adjusted position relative to the user, according to some embodiments of the present disclosure.

FIG. 7 illustrates a head-mountable device displaying an example user interface, according to some embodiments of the present disclosure.

FIG. 8 illustrates the head-mountable device of FIG. 7 displaying an example user interface, according to some embodiments of the present disclosure.

FIG. 9 illustrates a head-mountable device displaying an example user interface, according to some embodiments of the present disclosure.

FIG. 10 illustrates the head-mountable device of FIG. 9 displaying an example user interface, according to some embodiments of the present disclosure.

FIG. 11 illustrates a head-mountable device displaying an example user interface, according to some embodiments of the present disclosure.

FIG. 12 illustrates the head-mountable device of FIG. 11 displaying an example user interface, according to some embodiments of the present disclosure.

FIG. 13 illustrates a perspective front view of a head-mountable device displaying an example user interface, according to some embodiments of the present disclosure.

FIG. 14 illustrates a perspective front view of the head-mountable device of FIG. 13 displaying an example user interface, according to some embodiments of the present disclosure.

FIG. 15 illustrates a side view of a head-mountable device in use by a user, according to some embodiments of the present disclosure.

FIG. 16 illustrates the head-mountable device of FIG. 15 displaying an example user interface, according to some embodiments of the present disclosure.

FIG. 17 illustrates a head-mountable device and an electronic device displaying an example user interface, according to some embodiments of the present disclosure.

FIG. 18 illustrates the head-mountable device and the electronic device of FIG. 17 displaying an example user interface, according to some embodiments of the present disclosure.

FIG. 19 illustrates a block diagram of a head-mountable device and an electronic device, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mountable displays, headsets, visors, smartglasses, head-up display, etc., can perform a range of functions that are managed by the components (e.g., sensors, circuitry, and other hardware) included with the wearable device.

Many of the functions performed by a head-mountable device are optimally experienced when the components are in their most preferred position and orientation with respect to a user wearing the head-mountable device. For example, the head-mountable device can include a display that visually outputs display-based information toward the eyes of the user. The position and orientation of the displays relative to the eyes depends, at least in part, on how the head-mountable device is positioned on the face of the user.

Additionally, the head-mountable device, while on the face of the user, can provide greater comfort in particular positions than it would in other positions. For example, the placement may determine where and how the forces (e.g., weight and/or tension) of the head-mountable device are applied to the face. Face-engaging portions of the head-mountable device can be selected to engage certain portions of the face, but the experience by the user may be less than optimal if such face-engaging portions are placed at locations other than those intended. However, a head-mountable device with a more preferred placement can allow a user to comfortably wear and operate the head-mountable device for a longer duration.

A user or another person placing the head-mountable device on the face of the user may not recognize whether the head-mountable device is in the most optimal position to achieve these results. Accordingly, it can be desirable to provide guidance and/or feedback to the user to assist with placement of the head-mountable device in a preferred position.

Systems of the present disclosure can provide a head-mountable device with interface features to provide guidance for optimal placement of a head-mountable device. The head-mountable device and/or another electronic device can be operated to guide a user to position the head-mountable device in a manner that will achieve proper alignment of components with respect to the user and maximize user comfort. For example, the head-mountable device and/or another device can include sensors for detecting features of the user's face, forces distributed on the face when worn, and/or alignment with the face (e.g., eyes). The guidance can include instructions or other interface features to encourage adjustment of the head-mountable device. While the head-mountable device can provide such guidance to the user wearing it, the feedback can also be provided to another person and/or via another device.

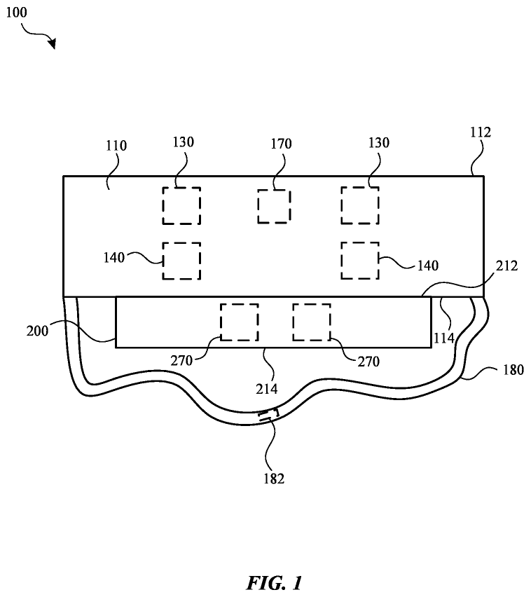

These and other embodiments are discussed below with reference to FIGS. 1-17. However, those skilled in the art will readily appreciate that the detailed description given herein with respect to these Figures is for explanatory purposes only and should not be construed as limiting.

According to some embodiments, for example as shown in FIG. 1, a head-mountable device 100 includes a frame 110 and a light seal 200. The frame 110 can be worn on a head of a user. The frame 110 can be positioned in front of the eyes of a user to provide information within a field of view of the user. The frame 110 and/or the light seal 200 can provide nose pads and/or other portions to rest on a user's nose, forehead, cheeks, and/or other facial features as described further herein.

The frame 110 can be supported on a user's head with the head engager 180. The head engager 180 can wrap around or extend along opposing sides of a user's head. The head engager 180 can optionally include earpieces for wrapping around or otherwise engaging or resting on a user's ears. It will be appreciated that other configurations can be applied for securing the head-mountable device 100 to a user's head. For example, one or more bands, straps, belts, caps, hats, or other components can be used in addition to or in place of the illustrated components of the head-mountable device 100. By further example, the head engager 180 can include multiple components to engage a user's head. The head engager 180 can extend from the frame 110 and/or the light seal 200.

The frame 110 can provide structure around a peripheral region thereof to support any internal components of the frame 110 in their assembled position. For example, the frame 110 can enclose and support various internal components (including for example integrated circuit chips, processors, memory devices and other circuitry) to provide computing and functional operations for the head-mountable device 100, as discussed further herein. While several components are shown within the frame 110, it will be understood that some or all of these components can be located anywhere within or on the head-mountable device 100. For example, one or more of these components can be positioned within the head engager 180, the light seal 200, and/or the frame 110 of the head-mountable device 100.

The head-mountable device 100 can include one or more user sensors for tracking features of the user wearing the head-mountable device 100. Such a sensor can be located at, included with, and/or associated with the frame 110, the light seal 200, and/or the head engager 180. For example, a user sensor can include or accompany a face sensor 170, a force sensor 270 of the light seal 200, and/or a head engagement sensor 182 of the head engager.

One or more sensors can be provided to detect a fit of the light seal 200 with respect to a face of a user. For example, the frame 110 and/or another component of the head-mountable device 100 can include a light sensor for detecting light within the light seal 200, as described further herein. By further example, the light seal 200 and/or another component of the head-mountable device 100 can include a force sensor 270 for detecting forces applied to regions of the face of the user, as described further herein. By further example, the head engager 180 and/or another component of the head-mountable device 100 can include a head engagement sensor 182 for detecting tension in or another condition of the head engager 180. Operation of such sensors can facilitate determination of which of a variety of light seals is recommended for user by a particular user.

By further example, a user sensor can perform facial feature detection, facial movement detection, facial recognition, eye tracking, user mood detection, user emotion detection, voice detection, etc. Such eye tracking may be used to determine a location of information to be displayed on the displays 140 and/or a portion (e.g., object) of a view to be analyzed by the head-mountable device 100. By further example, the user sensor can be a bio-sensor for tracking biometric characteristics, such as health and activity metrics. The user sensor can include a bio-sensor that is configured to measure biometrics such as electrocardiographic (ECG) characteristics, galvanic skin resistance, and other electrical properties of the user's body. Additionally or alternatively, a bio-sensor can be configured to measure body temperature, exposure to UV radiation, and other health-related information.

The frame 110 can include and/or support one or more cameras 130. The cameras 130 can be positioned on or near an outer side 112 of the frame 110 to capture images of views external to the head-mountable device 100. As used herein, an outer side of a portion of a head-mountable device is a side that faces away from the user and/or towards an external environment. The captured images can be used for display to the user or stored for any other purpose. Each of the cameras 130 can be movable along the outer side 112. For example, a track or other guide can be provided for facilitating movement of the camera 130 therein.

The head-mountable device 100 can include displays 140 that provide visual output for viewing by a user wearing the head-mountable device 100. One or more displays 140 can be positioned on or near an inner side 114 of the frame 110. As used herein, an inner side 114 of a portion of a head-mountable device is a side that faces toward the user and/or away from the external environment.

A display 140 can transmit light from a physical environment (e.g., as captured by a camera) for viewing by the user. Such a display 140 can include optical properties, such as lenses for vision correction based on incoming light from the physical environment. Additionally or alternatively, a display 140 can provide information as a display within a field of view of the user. Such information can be provided to the exclusion of a view of a physical environment or in addition to (e.g., overlaid with) a physical environment.

A physical environment refers to a physical world that people can interact with and/or sense without necessarily requiring the aid of an electronic device. A computer-generated reality environment relates to a partially or wholly simulated environment that people sense and/or interact with the assistance of an electronic device. Examples of computer-generated reality include, but are not limited to, mixed reality and virtual reality. Examples of mixed realities can include augmented reality and augmented virtuality. Examples of electronic devices that enable a person to sense and/or interact with various computer-generated reality environments include head-mountable devices, projection-based devices, heads-up displays (HUDs), vehicle windshields having integrated display capability, windows having integrated display capability, displays formed as lenses designed to be placed on a person's eyes (e.g., similar to contact lenses), headphones/earphones, speaker arrays, input devices (e.g., wearable or handheld controllers with or without haptic feedback), smartphones, tablets, and desktop/laptop computers. A head-mountable device can have an integrated opaque display, have a transparent or translucent display, or be configured to accept an external opaque display from another device (e.g., smartphone).

While the light seal 200 is shown schematically with a particular size and shape, it will be understood that the size and shape of the light seal 200, particularly at the inner side 214 of the light seal 200, opposite an outer side 212, can have a size and shape that accommodates the face of a user wearing the head-mountable device 100. For example, the inner side 214 can provide a shape that generally matches the contours of the user's face around the eyes of the user, as described further herein. The inner side 214 can be provided with one or more features that allow the light seal 200 to conform to the face of the user to enhance comfort and block light from entering the light seal 200 at the points of contact with the face. For example, the inner side 214 can provide a flexible, soft, elastic, and/or compliant structure.

While the head-mountable device 100 is worn by a user, with the inner side 214 of the light seal 200 against the face of the user and/or with the head engager 180 against the head of the user, the light seal 200 can remain in a fixed location and orientation with respect to the face and head of the user. Furthermore, in such a configuration the frame 110 can also be maintained in a fixed location and orientation with respect to the face and head of the user. Given the variety of head and face shapes that different users may have, it can be desirable to provide a light seal 200 with customization and exchangeability so that the frame 110 is in a desired position and orientation with respect to the face and head of the user during use.

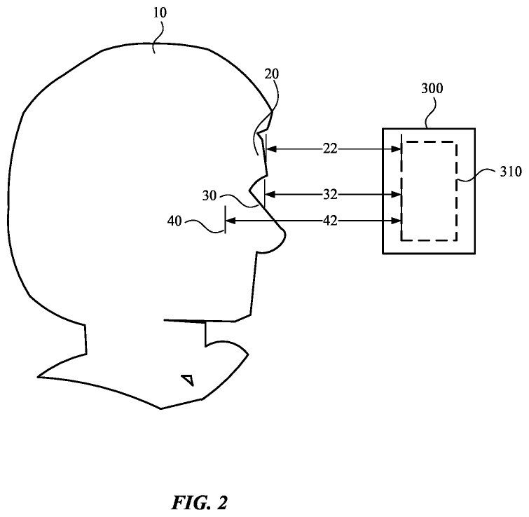

Referring now to FIG. 2, the shape of a user's face can be measured to later determine how a given head-mountable device should be positioned to optimize user comfort and alignment with features of the user's face. A device having a face sensor can be operated to detect and/or measure one or more regions of a face of a user. Such detections and measurements can be used to determine how a head-mountable device should be positioned so that the light seal thereof comfortably engages the appropriate regions of the user's face.

As shown in FIG. 2, an electronic device 300 can provide a sensor 310 that is operable to measure distances to multiple regions of the face of a user 10. Such regions can include the regions that would be engaged by a light seal when a head-mountable device is worn by the user. For example, the regions can include a forehead 20, a nose 30, and/or one or both cheeks 40.

The face sensor 370 can include one or more types of sensors. For example, the face sensor 370 can include one or more image sensors, depth sensors, thermal (e.g., infrared) sensors, and the like. By further example, a depth sensor can be configured to measure a distance (e.g., range) to an object (e.g., region of the user's face) via stereo triangulation, structured light, time-of-flight, interferometry, and the like. Additionally or alternatively, the face sensor and/or the device can capture and/or process an image based on one or more of hue space, brightness, color space, luminosity, and the like.

In FIG. 2, by way of example, the face sensor 370 is depicted as a component of an electronic device. Examples of such an electronic device include a portable computing device, a tablet device, a laptop computer, a smartphone, a smart watch, or other appropriate devices that include one or more sensors. Additionally or alternatively, the face sensor 370 can be a component of a head-mountable device, such as the head-mountable device to be worn by the user and/or another head-mountable device. In some embodiments, the electronic device 300 can be maintained at a fixed location with respect to the user 10, or the electronic device can be moved to map different regions of the face of the user.

The face sensor 370 can measure a distance from the face sensor 370 to each of multiple regions of the face of the user. For example, the face sensor 370 can measure a forehead distance 22 to a forehead 20 of the user 10. By further example, the face sensor 370 can measure a nose distance 32 to a nose 30 of the user 10. By further example, the face sensor 370 can measure a cheek distance 42 to a cheek 40 of the user 10. The face sensor 370 can measure any other regions of the face, such as the eyes and/or other portions that are not to be directly engaged by the light seal. It will be understood that other regions of the face can be detected and/or measured. Additionally or alternatively, one or multiple distance measurements can be made to each of various regions, such as with respect to multiple sections of the forehead 20, nose 30, and/or cheeks 40. Based on the distance measurements, a head-mountable device can be selected with, optionally, a custom light seal that is selected with various portions that match the contours of the face of the user.

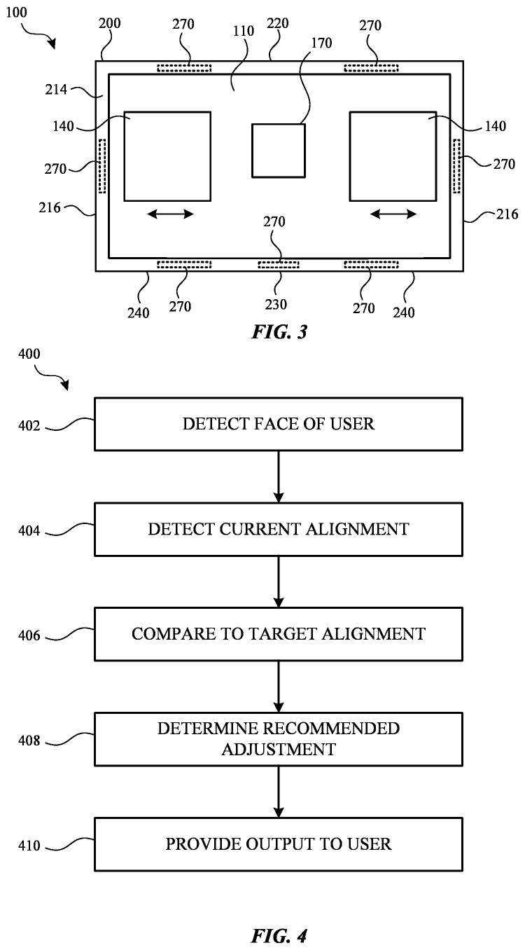

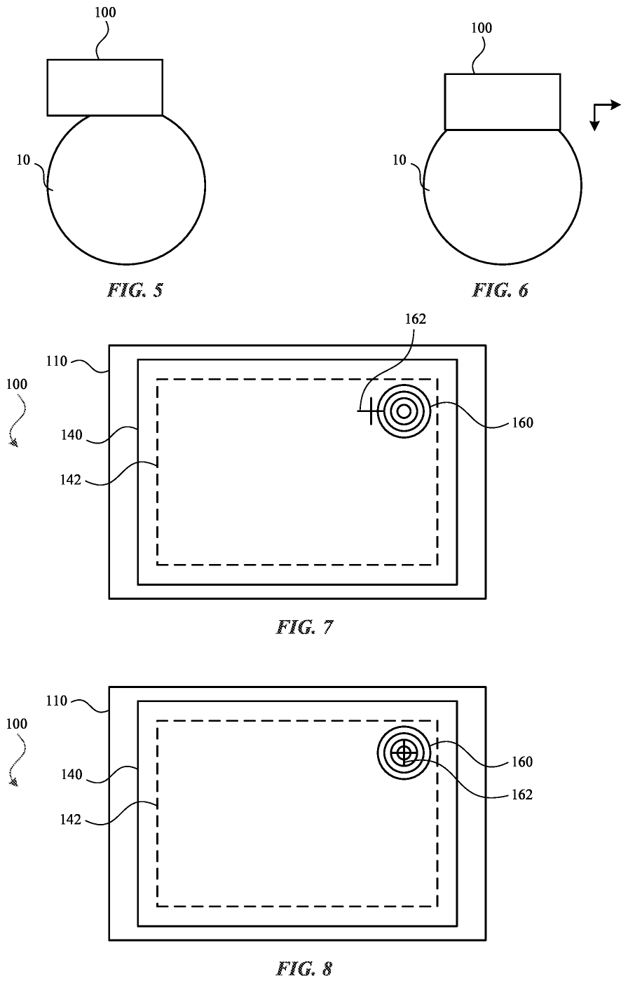

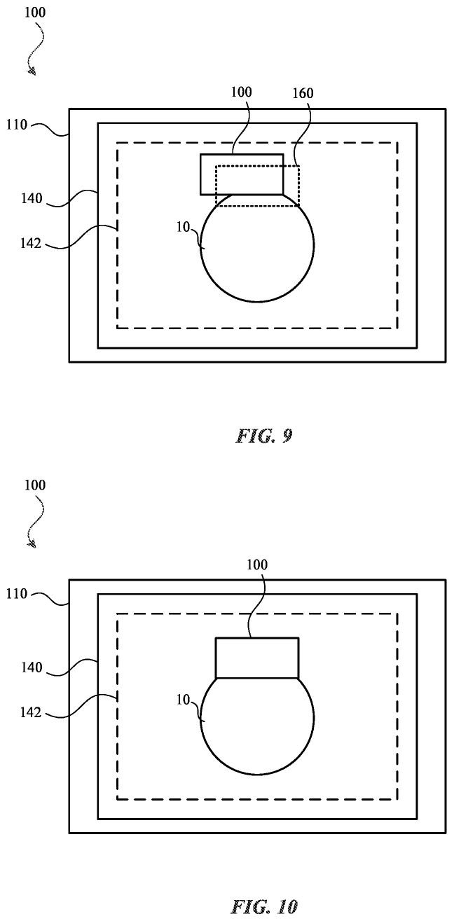

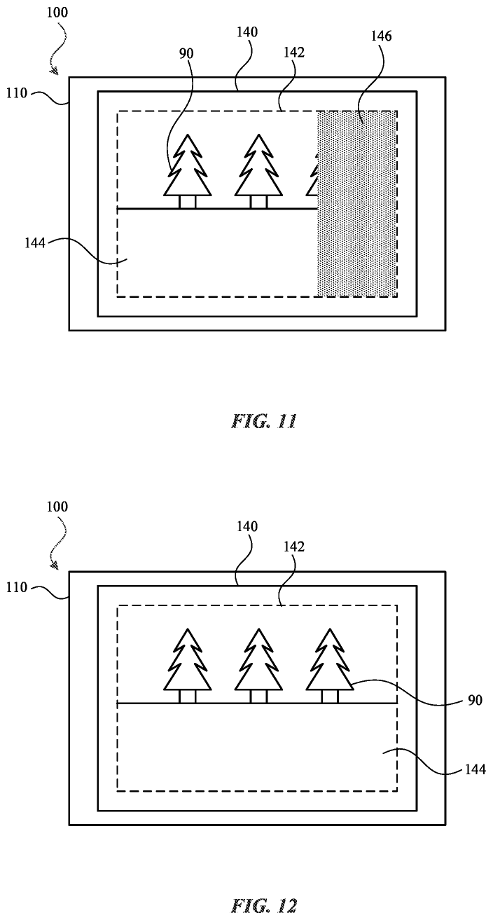

Referring now to FIG. 3, a head-mountable device can include a light seal that is selected to match the contours of the face of the user. The head-mountable device can further include features to monitor alignment and engagement of the head-mountable device on the face of the user.

For example, as shown in FIG. 3, a light seal 200 can include a forehead portion 220 for engaging the forehead of the user, a nose portion 230 for engaging the nose of the user, and cheek portions 240 for engaging the cheeks of the user. By further example, the light seal 200 can further include side portions 216 configured to engage side of the user's face (e.g., along the temples of the user's head). Any number of other portions can be provided, including sub-components of the portions described herein. Different light seals can differ from each other at least with respect to the dimensions along different portions thereof. For example, different light seals can have different thicknesses along different portions to accommodate the face of various different users. A given light seal can be selected for use with a given user having facial features for engagement by the light seal, and a target position of the head-mountable device can be determined for optimal comfort and/or alignment (e.g., with the eyes of the user).

While the head-mountable device 100 can have a target alignment for the entire device, certain features of the head-mountable device 100 can adjust their respective position and/or orientation to align with features of the user. For example, each display 140 can be adjusted to align with a corresponding eye of the user. By further example, each display 140 can be moved along one or more axes until a center of each display 140 is aligned with a center of the corresponding eye. Accordingly, the distance between the displays 140 can be set based on an interpupillary distance of the user. IPD is defined as the distance between the centers of the pupils of a user's eyes.

The pair of displays 140 can be mounted to the frame 110 and separated by a distance. The distance between the pair of displays 140 can be designed to correspond to the IPD of a user. The distance can be adjustable to account for different IPDs of different users that may wear the head-mountable device 100. For example, either or both of the displays 140 may be movably mounted to the frame 110 to permit the displays 140 to move or translate laterally to make the distance larger or smaller. Any type of manual or automatic mechanism may be used to permit the distance between the displays 140 to be an adjustable distance. For example, the displays 140 can be mounted to the frame 110 via slidable tracks or guides that permit manual or electronically actuated movement of one or more of the displays 140 to adjust the distance there between.

Additionally or alternatively, the displays 140 can be moved to a target location based on a desired visual effect that corresponds to user's perception of the display 140 when it is positioned at the target location. The target location can be determined based on a focal length of the user and/or optical elements of the system. For example, the user's eye and/or optical elements of the system can determine how the visual output of the display 140 will be perceived by the user. The distance between the display 140 and the user's eye and/or the distance between the display 140 and one or more optical elements can be altered to place the display 140 at, within, or outside of a corresponding focal distance. Such adjustments can be useful to accommodate a particular user's eye, corrective lenses, and/or a desired optical effect.

It will be understood that placement the entire head-mountable device can also alter the position and/or orientation of the displays 140 with respect to the eyes of the user. As such, the head-mountable device can provide guidance to help a user achieve alignment of the head-mountable device with respect to the user while also performing additional adjustments, such as movement of the displays 140.

A light seal or other component of the head-mountable device can also include sensors that are operated to detect and/or measure one or more forces on the face of a user. Such detections and measurements can be used to determine alignment and fit of the head-mountable device of the face of the user.

As shown in FIG. 3, a light seal 200 or other component of the head-mountable device 100 can provide force sensors 270 that are operable to measure magnitudes of forces applied to multiple regions of the face of a user. Such regions can include the regions that are engaged by the light seal 200 as the head-mountable device 100 is worn by the user. For example, the regions can include a forehead, a nose, and/or one or both cheeks. Accordingly, the force sensors 270 can be positioned at the forehead portion 220, the side portions 216, the nose portion 230, and/or the cheek portions 240.

The force sensors 270 can include one or more types of sensors. The force sensors 270 can include a component that converts mechanical motion and/or deformation of the light seal 200 into an electric signal. The force sensor 270 can include one or more contact sensors, capacitive sensors, strain gauges, resistive touch sensors, piezoelectric sensors, cameras, pressure sensors, photodiodes, and/or other sensors. The force sensor 270 can detect both the presence and magnitude of a force.

Each of the force sensors 270 can measure a force applied to the face of the user at its vicinity. For example, the force sensors 270 can measure forces applied to the forehead, nose, cheeks, and/or temples of the user. It will be understood that other regions of the face where contact is made can be detected and/or measured. Additionally or alternatively, one or multiple force measurements can be made to each of various regions, such as with respect to multiple sections of the forehead, nose, and/or cheeks.

Based on the force measurements, adjustments to the head-mountable device may be determined to be recommended. For example, a target alignment can be one in which the forces at different regions are evenly distributed or otherwise balanced. By further example, where forces are measured to be excessively high in a given region (e.g., above a threshold associated with the limit of a user's comfort range at that region), an adjustment can be recommended. It will be understood that the threshold for one region of the user's face can be different than the threshold for another region of the user's face. For example, a threshold within which a forehead of a particular user can comfortably withstand forces may be greater than a threshold within which a cheek of the user can comfortably withstand forces. As such, adjustments can be recommended to alleviate forces in one region by shifting them to another region. By further example, recommended adjustments can include adjusting the tension of a head engager.

Additionally or alternatively, the head-mountable device 100 can detect the position and/or orientation thereof by one or more onboard sensors. For example, the head-mountable device 100 can include an initial measurement unit (“IMU”) that provides information regarding a characteristic of the head-mounted device 100, such as inertial angles thereof. For example, the IMU can include a six-degrees of freedom IMU that calculates the head-mounted device's position, velocity, and/or acceleration based on six degrees of freedom (x, y, z, θₓ, θ_{y}, and θ_{z}). The IMU can include one or more of an accelerometer, a gyroscope, and/or a magnetometer. Additionally or alternatively, the head-mounted device can detect motion characteristics of the head-mounted device with one or more other motion sensors, such as an accelerometer, a gyroscope, a global positioning sensor, a tilt sensor, and so on for detecting movement and acceleration of the head-mounted device. Where such movement is detected, a determination can be made that the head-mountable device 100 has moved, for example from a target alignment, thereby requiring adjustment to return thereto.

FIG. 4 illustrates a flow diagram of an example process 400 for guiding a user with adjustment assistance. For explanatory purposes, the process 400 is primarily described herein with reference to the head-mountable device 100 of FIGS. 1 and 3 and/or the electronic device 300 of FIG. 2. However, the process 400 is not limited to the head-mountable device 100 of FIGS. 1 and 3 and/or the electronic device 300 of FIG. 2, and one or more blocks (or operations) of the process 400 may be performed by different components of the head-mountable device and/or one or more other devices. Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

The process 400 can begin when the head-mountable device detects a face of a user (402). Such a detection can be made by one or more sensors of the head-mountable device. Additionally or alternatively, the detection can be performed in response to an operational state of the head-mountable device (e.g., on/off state, application launch, user input command, and the like).

The head-mountable device can detect the current alignment of the head-mountable device with respect to the face of the user (404). For example, an eye sensor can detect an eye of the user and determine its location with respect to the head-mountable device. By further example, a force sensor of the head-mountable device can measure one or more forces applied to one or more regions of the face. Such regions can include a forehead, nose, and/or cheeks of the user. By further example, the detection of a current alignment can be performed by another electronic device, as described further herein.

The head-mountable device can compare the current alignment of the head-mountable device to a target alignment (406). The target alignment can be one in which the components of the head-mountable device, such as the displays, are aligned (e.g., within a range) with features of the user's face, such as the eyes. Additionally or alternatively, the target alignment can be one in which the head-mountable device engages a face of the user with relatively greater comfort than is provided with other alignments. For example, in a target alignment the forces can be distributed in a manner that is evenly distributed and/or distributed according to the ability of the facial regions to withstand such forces.

Based on the current alignment, the target alignment, and the comparison there between, the head-mountable device can determine whether an adjustment is recommended and, if so, what adjustment is recommended (408). For example, the head-mountable device can determine the change in position and/or orientation that would be required to change from the current alignment to the target alignment. In some embodiments, an adjustment can be to the frame, the light seal, the head engager, and/or another component of the head-mountable device. For example, the recommended adjustment can include tightening or loosening the head engager, which can alter the engagement of the light seal on the face of the user. Such a recommendation can be based, at least in part, on detections made by a head engagement sensor of the head engager. By further example, the recommended adjustment can include exchanging a current light seal for a different light seal that has different dimension, thereby being capable of placing components of the head-mountable device at a different position and/or orientation with respect to the user.

Optionally, the determination of a recommended adjustment can be based, at least in part, on an operational mode and/or activity of the head-mountable device and/or the user. For example, the head-mountable device can recognize and/or provide an indication that an active operation, program, application, and/or activity involves a magnitude and/or type of movement by the user. A particular alignment and/or adjustment may be recommended to maintain engagement with the face of the user during such an operational mode. Accordingly, the head-mountable device and/or other device can determine the recommended alignment and/or adjustment for a duration of time (e.g., throughout the duration of the operational mode).

The head-mountable device and/or another device can provide an output to a user based on the recommended adjustment, if any (410). For example, the head-mountable device can provide a visual output on the displays, a sound, or other output that communicates to the user an indication of the recommended alignment and/or adjustment. The user can then take appropriate actions to effect the recommended adjustment. In some examples, the head-mountable device can communicate with another device, which then provides the output. The output can include instructions for achieving the recommended adjustment, as described further herein.

Referring now to FIGS. 5 and 6, a head-mountable device can be adjusted to move from a current alignment to a target alignment. For example, as shown in FIG. 5, a head-mountable device 100 can be detected to be in an alignment with respect to the user 10 that is different than a target alignment. Where such a detection is made, the head-mountable device 100 can provide an output that prompts and/or guides a user to effect an adjustment to the head-mountable device 100. For example, as shown in FIG. 6, the head-mountable device 100 can be moved to a new position with respect to the user 10 to achieve the target alignment. As used herein, movement, adjustment, or other actions that alter the position, orientation, and/or alignment of the head-mountable device 100 with respect to the user 10 can include any change in three-dimensional space, including movement along and/or rotation about any one or more of axes. For example, movement to a new position can include movement across the user's face (e.g., adjustments along a coronal plane of the user 10) and/or movement that adjusts a distance between the head-mountable device 100 and the user's face (e.g., adjustments along a sagittal and/or transverse plane of the user 10). Such movement can improve alignment (e.g., centering) with respect to the user as well as positioning the head-mountable device 100 to be at a target distance away from the user 10 (e.g., the user's eyes) to maximize the comfort and enhance the experience of the user.

Referring now to FIGS. 7 and 8, a head-mountable device can provide a user interface to prompt and/or guide a user to adjust the head-mountable device to achieve a target alignment. FIG. 4 illustrates a rear view of a head-mountable device operable by a user, the head-mountable device providing a user interface, according to some embodiments of the present disclosure. The display 140 can provide a user interface 142. Not all of the depicted graphical features may be used in all implementations, however, and one or more implementations may include additional or different graphical features than those shown in the figure. Variations in the arrangement and type of the graphical features may be made without departing from the spirit or scope of the claims as set forth herein. Additional components, different components, or fewer components may be provided.

As shown in FIG. 7, the user interface 142 can include one or more visual features. For example, the user interface 142 can include a target 160 and an indicator 162, such as a reticle, crosshairs, a point, a line, and the like. It will be understood that a variety of visual features can be provided, such as arrows, a compass, a heatmap, and the like. It will be understood that such visual features can be provided in addition to other visual features, such as a view captured by a camera of the head-mountable device. The position of the indicator 162 relative to the target 160 can represent the position of the head-mountable device 100 relative to the user. Where the head-mountable device 100 is not in a target alignment, the indicator 162 can be positioned away from at least a portion of the target 160, for example in a manner that suggests the direction in which the user should move the head-mountable device 100 to achieve the target alignment.

As shown in FIG. 8, when the user moves the head-mountable device 100 relative to the face, the indicator 162 can be moved with respect to the target 160. When the head-mountable device 100 is placed in the target alignment, the indicator 162 can be displayed over the target 160 (e.g., at a center of the target 160). Such updates to the user interface 142 can serve as confirmation when the target alignment has been achieved.

Referring now to FIGS. 9 and 10, a head-mountable device can provide a user interface with a rendered view of the head-mountable device and a user to prompt and/or guide the user to adjust the head-mountable device to achieve a target alignment.

As shown in FIG. 9, the user interface 142 can include one or more visual features. For example, the user interface 142 can include a target 160 and a view of the head-mountable device 100 in a current alignment with respect to the user 10. The view of the user 10 and/or the head-mountable device can be rendered based on detections and/or measurement performed by the head-mountable device and/or another device. For example, the head-mountable device 100 and the user 10 can be virtual objects in the user interface 142. Additionally or alternatively, the head-mountable device 100 and the user 10 can be provided as a view captured by an external camera. The position of the head-mountable device 100 relative to the target 160 can illustrate how the head-mountable device 100 is to be adjusted to achieve a target alignment. Where the head-mountable device 100 is not presently in a target alignment, the head-mountable device 100 can be positioned away from at least a portion of the target 160, for example in a manner that suggests the direction in which the user should move the head-mountable device 100 to achieve the target alignment.

As shown in FIG. 10, when the user moves the head-mountable device 100 relative to the face, the head-mountable device 100 in the user interface 142 can be moved with respect to the target 160. When the head-mountable device 100 is placed in the target alignment, the head-mountable device 100 shown in the user interface 142 can be displayed over the target 160. Such updates to the user interface 142 can serve as confirmation when the target alignment has been achieved.

Referring now to FIGS. 11 and 12, a head-mountable device can provide a user interface with a modified visual output to prompt and/or guide the user to adjust the head-mountable device to achieve a target alignment.

As shown in FIG. 11, the user interface 142 can include a depiction of a visual feature 90. The object can correspond to a physical object captured by a camera of the head-mountable device 100 or another object, such as a virtual object, menu, text, image, and the like. It will be understood that the head-mountable device 100 can be operated in a manner that allows the user to adjust the view by moving and/or rotating the head-mountable device 100 on the face of the user. As such, the user's view can be limited to prompt and/or guide the user to adjust the head-mountable device 100.

As shown in FIG. 11, the user interface 142 can include an active portion 144 and a blocked portion 146. The blocked portion 146 can replace a portion of the view that would otherwise be provided via the user interface 142, including for example a view captured by a camera of the head-mountable device 100. In some embodiments, the location, size, and/or other characteristic of the blocked portion 146 in the user interface 142 can indicate to the user the manner in which the head-mountable device is to be adjusted. For example, the blocked portion 146 can be provided on a side that corresponds to the direction in which the head-mountable device 100 is to be moved (e.g., towards such a direction or away from such a direction). By further example, the size of the blocked portion 146 can correspond to the amount of movement that is required to achieve the target alignment.

As shown in FIG. 12, when the user moves the head-mountable device 100 relative to the face to achieve the target alignment, the blocked portion 146 of the user interface 142 can be removed such that only the active portion 144 remains, for example showing the visual features 90 without the modification that would be applied when the head-mountable device is not in the target alignment. When the head-mountable device 100 is placed in the target alignment, the presentation of the active portion 144 without the blocked portion 146 can serve as confirmation that the target alignment has been achieved.

Additionally or alternatively, the visual feature 90 can be moved to and/or provided at a side of the user interface 142 that corresponds to a direction of the recommended adjustment by the user. For example, where the recommended adjustment includes moving the head-mountable device upward with respect to the face, the visual feature 90 can be moved and/or provided at an upper side of the user interface 142 to encourage the user to move the head-mountable device to bring and maintain the visual feature 90 within a central region of the user interface 142. By further example, at least a portion of the visual feature 90 can be moved outside of the view of the user interface 142. Such an action can be provided as an animation to notify the user of the shift so that the user can move the head-mountable device in a direction that maintains the visual feature 90 within a field of view of the user.

Referring now to FIGS. 13 and 14, a head-mountable device can provide a user interface on an outwardly facing side thereof to prompt and/or guide adjustment the head-mountable device to achieve a target alignment.

As shown in FIG. 13, the head-mountable device 100 can include a display 172 on an outer side 112 of the frame 110. Accordingly, the display 172 can be on the side that is opposite the inner side 114, which engages the user's face and/or couples to a light seal for engaging the user's face. Accordingly, the display 172 can be operated to provide guidance to another person who can help the user wearing the head-mountable device 100 to achieve the target alignment. Such guidance and/or feedback can be helpful where the user wearing the head-mountable device 100 requires or otherwise benefits from another's assistance.

The display 172 can output one or more visual features. For example, the display 172 can include an indicator 174, such as arrows, a compass, a heatmap, a reticle, crosshairs, a point, a line, and the like. The indicator 174 can be an instruction to move the head-mountable device 100 in a particular manner. For example, where the head-mountable device 100 is not in a target alignment, the indicator 174 can show the direction in which the user should move the head-mountable device 100 to achieve the target alignment.

As shown in FIG. 14, when the user moves the head-mountable device 100 relative to the face, the indicator 174 can be updated to provide new directions and/or a confirmation that the target alignment has been achieved. For example, when the head-mountable device 100 is placed in the target alignment, the indicator 174 can indicate that no directional adjustments are suggested. Such updates to the display 172 can serve as confirmation when the target alignment has been achieved.

Referring now to FIGS. 13 and 14, a head-mountable device can provide a user interface on an outwardly facing side thereof to prompt and/or guide adjustment the head-mountable device to achieve a target alignment.

As shown in FIG. 13, the head-mountable device 100 can include a display 172 on an outer side 112 of the frame 110. Accordingly, the display 172 can be on the side that is opposite the inner side 114, which engages the user's face and/or couples to a light seal for engaging the user's face. Accordingly, the display 172 can be operated to provide guidance to another person who can help the user wearing the head-mountable device 100 to achieve the target alignment. Such guidance and/or feedback can be helpful where the user wearing the head-mountable device 100 requires or otherwise benefits from another's assistance.

The display 172 can output one or more visual features. For example, the display 172 can include an indicator 174, such as arrows, a compass, a heatmap, a reticle, crosshairs, a point, a line, and the like. The indicator 174 can be an instruction to move the head-mountable device 100 in a particular manner. For example, where the head-mountable device 100 is not in a target alignment, the indicator 174 can show the direction in which the user should move the head-mountable device 100 to achieve the target alignment.

As shown in FIG. 14, when the user moves the head-mountable device 100 relative to the face, the indicator 174 can be updated to provide new directions and/or a confirmation that the target alignment has been achieved. For example, when the head-mountable device 100 is placed in the target alignment, the indicator 174 can indicate that no directional adjustments are suggested. Such updates to the display 172 can serve as confirmation when the target alignment has been achieved.

Referring now to FIGS. 15 and 16, in addition to providing guidance to a person other than the user wearing a head-mountable device, the user can view an externally facing display while wearing the head-mountable device.

As shown in FIG. 15, a user 10 wearing the head-mountable device 100 can observe a view captured by a camera 130 of the head-mountable device 100. While an externally facing display may not be immediately within the field of view captured by the camera 130, the user 10 can observe a mirror 500 or other reflective surface to bring the user 10 and/or the head-mountable device 100 within the field of view.

As shown in FIG. 16, the display 140 can provide a user interface 142 that includes a view captured by the camera. For example, the user interface 142 can include a reflected view of the user 10 and/or the head-mountable device 100. With such a view, the user 10 can observe how adjustments to the head-mountable device 100 can and should be made. By further example, the user interface 142 can include a reflected view of the display 172, including any indicators 174 provided thereon, as described herein. Additionally or alternatively, the user interface 142 can provide one or more other indicators, such as a target location for the head-mountable device 100. Other indicators can include any one or more of those described with respect to the user interfaces of FIGS. 7-12.

Referring now to FIGS. 17 and 18, a head-mountable device can provide a user interface on another electronic device to prompt and/or guide adjustment the head-mountable device to achieve a target alignment.

As shown in FIG. 17, a system 2 can include a head-mountable device 100 and an electronic device 300 that is separately operably from the head-mountable device 100. The electronic device 300 can provide a camera 330 that captures an image of the head-mountable device 100 and/or a user (not shown). In some embodiments, the camera and/or one or more other sensors can be operated to detect an alignment of the head-mountable device 100. For example, the head-mountable device 100 can include one or more fiducial markers 116, for example at an outer side 112, that can be imaged by the camera 330. Based on a known arrangement of the fiducial markers, the electronic device 300 can determine the position and/or orientation of the entire head-mountable device 100. Additionally or alternatively, the electronic device 300 can measure distances to multiple regions of the head-mountable device 100 and/or the face of a user 10, as described herein. For example, the electronic device 300 can include one or more image sensors, depth sensors, thermal (e.g., infrared) sensors, and the like. In some embodiments, the electronic device 300 can optically measure an amount of compression of the head-mountable device, for example at a light seal against the face of the user. Based on such compression, the electronic device 300 can infer forces applied and recommend adjustments as appropriate.

In some embodiments, the electronic device 300 can be in communication with the head-mountable device 100, such that detections and/or recommended adjustments can be determined by the head-mountable device 100 and transmitted to the electronic device 300. It will be understood that detections of the head-mountable device 100 and the electronic device 300 can be combined to determine a recommended adjustment.

Based on the detected position and/or orientation of the head-mountable device 100 and/or other conditions thereof with respect to the user, the electronic device 300 and/or the head-mountable device 100 can compare the current alignment with a target alignment. Based on the results of the comparison, the electronic device 300 and/or the head-mountable device 100 can determine a recommended adjustment.

The electronic device 300 can include a display 340 that outputs a user interface 342. It will be understood that the electronic device 300 can be operated by a person that is not the user wearing the head-mountable device. As such, the additional person can receive guidance to assist the user with any recommended adjustments.

The display 340 can output one or more visual features. For example, the display 340 can include an indicator 360, such as arrows, a compass, a heatmap, a reticle, crosshairs, a point, a line, and the like. Such indicators can optionally be provided in addition to and/or overlaid with a view of the head-mountable device 100 and/or the user (e.g., as captured by the camera 330). The indicator 360 can be an instruction to move the head-mountable device 100 in a particular manner. For example, where the head-mountable device 100 is not in a target alignment, the indicator 360 can show the direction in which the user should move the head-mountable device 100 to achieve the target alignment.

As shown in FIG. 18, when the user or another person moves the head-mountable device 100 relative to the face, the indicator 360 can be updated to provide new directions and/or a confirmation that the target alignment has been achieved. For example, when the head-mountable device 100 is placed in the target alignment, the indicator 360 can indicate that no directional adjustments are suggested. Such updates to the user interface 342 can serve as confirmation when the target alignment has been achieved.

Other types of output can be provided to prompt a user to make adjustments. For example, the outputs can include instructions to move the head-mountable device in a particular way. Additionally or alternatively, content can be remove or modified until the user makes the recommended adjustment. For example, visual features can be presented as blurry, blocked, occluded, dim, and/or transparent until the user makes the recommended adjustment. Additionally or alternatively, content can be added or modified until the user makes the recommended adjustment. For example, visual features can be presented as highlighted, opaque, and/or brighter until the user makes the recommended adjustment.

Outputs provided by a head-mountable device 100 and/or an electronic device 300 can include visual features via a display. Additionally or alternatively, outputs can include other types of interactions with a user, such as sound via a speaker of the head-mountable device 100 and/or the electronic device 300 and/or haptic feedback via a haptic device of the head-mountable device 100 and/or the electronic device 300. It will be understood that multiple outputs can be provided in combination (e.g., simultaneously or at different times). Different types of outputs can be provided for different types of indicators to the user (e.g., to indicate adjustment is needed or that a target alignment has been achieved).

It will be understood that adjustments of a user interface as described herein can be repeated as needed to achieve different target alignments after successive durations of time. As such, the outputs can be dynamically updated based on multiple detections and determinations as described herein.

It will be further understood that the objective of adjusting a current alignment and/or achieving a target alignment can include multiple stages. For example, the user can be prompted to perform a sequence of adjustments to achieve each of different target alignments.

It will be further understood that such measures can be temporary. For example, the user can be prompted to take certain actions. Thereafter, the user can resume operation according to a prior mode until adjustments are again determined to be recommended.

It will be further understood that other adjustments to visual features or other outputs can be provided to prompt the user to make recommended adjustments to alignment. For example, a visual feature or certain functionality of the head-mountable device 100 can be revoked or omitted until the user performs a recommended adjustment to alignment and/or until the user achieves a target alignment. Upon such user action, the visual feature or other functionality of the head-mountable device 100 can be restored.

For example, the user can be blocked from access to certain functions (e.g., apps, programs, content, experiences, commands, outputs, and the like) until certain actions are performed by the user according to the recommended adjustment. Such actions can include moving the head-mountable device in a way that adjusts its alignment with respect to the user.

Other recommendations can include adjusting a fit and/or configuration of the head-mountable device 100. For example, the head-mountable device 100 can recommend that the user adjust the fit, position, orientation, and/or tightness of the head-mountable device 100 on the head of the user. By further example, the head-mountable device 100 can recommend that the user adjust the head-mountable device 100 to provide a different effect on the user. Such adjustments can include exchanging components, removing components, and/or adding components, such as a counter-balance to adjust the weight distribution of the head-mountable device 100.

Referring now to FIG. 19, components of the head-mountable device can be operably connected to provide the performance described herein. FIG. 19 shows a simplified block diagram of an illustrative head-mountable device 100 and an electronic device 300 in accordance with one embodiment of the invention. It will be appreciated that components described herein can be provided on one, some, or all of a frame, a light seal, and/or a head engager. It will be understood that additional components, different components, or fewer components than those illustrated may be utilized within the scope of the subject disclosure.

As shown in FIG. 19, the head-mountable device 100 can include a processor 150 (e.g., control circuitry) with one or more processing units that include or are configured to access a memory 152 having instructions stored thereon. The instructions or computer programs may be configured to perform one or more of the operations or functions described with respect to the head-mountable device 100. The processor 150 can be implemented as any electronic device capable of processing, receiving, or transmitting data or instructions. For example, the processor 150 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The memory 152 can store electronic data that can be used by the head-mountable device 100. For example, the memory 152 can store electrical data or content such as, for example, audio and video files, documents and applications, device settings and user preferences, timing and control signals or data for the various modules, data structures or databases, and so on. The memory 152 can be configured as any type of memory. By way of example only, the memory 152 can be implemented as random access memory, read-only memory, Flash memory, removable memory, or other types of storage elements, or combinations of such devices.

The head-mountable device 100 can further include a display 140 for displaying visual information for a user. The display 140 can provide visual (e.g., image or video) output. The display 140 can be or include an opaque, transparent, and/or translucent display. The display 140 may have a transparent or translucent medium through which light representative of images is directed to a user's eyes. The display 140 may utilize digital light projection, OLEDs, LEDS, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. The head-mountable device 100 can include an optical subassembly configured to help optically adjust and correctly project the image-based content being displayed by the display 140 for close up viewing. The optical subassembly can include one or more lenses, mirrors, or other optical devices.

The head-mountable device 100 can further include a camera 130 for capturing a view of an external environment, as described herein. The view captured by the camera can be presented by the display 140 or otherwise analyzed to provide a basis for an output on the display 140.

The head-mountable device 100 can include an input/output interface 186, which can include any suitable component for connecting head-mountable device 100 to other devices and/or communicating with a user. The input/output interface 186 can include buttons, keys, a crown, microphone, a motion sensor, a mouse, and handheld controller, or another feature that can act as an input interface for operation by the user. The input/output interface 186 can include a display, speaker, haptic feedback device, or another feature that can act as an output interface for operation by the user. Other suitable components can include those for communicating with another device, such as audio/video jacks, data connectors, or any additional or alternative input/output interface.

The head-mountable device 100 can include the microphone 188 as described herein. The microphone 188 can be operably connected to the processor 150 for detection of sound levels and communication of detections for further processing, as described further herein.

The head-mountable device 100 can include the speakers 190 as described herein. The speakers 190 can be operably connected to the processor 150 for control of speaker output, including sound levels, as described further herein.

The head-mountable device 100 can include communications circuitry 192 for communicating with one or more servers or other devices using any suitable communications protocol. For example, communications circuitry 192 can support Wi-Fi (e.g., a 802.11 protocol), Ethernet, Bluetooth, high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. Communications circuitry 192 can also include an antenna for transmitting and receiving electromagnetic signals.

The head-mountable device 100 can include one or more face sensors 170 that are operable to identify, detect, and/or measure multiple regions of the face of a user 10, as described herein.

The head-mountable device 100 can include one or more force sensors 270 for detecting forces applied to regions of the face of the user, as described herein.

The head-mountable device 100 can include one or more head engagement sensor 182 for detecting tension in or another condition of the head engager 180, as described herein.

The head-mountable device 100 can include one or more other sensors. Such sensors can be configured to sense substantially any type of characteristic such as, but not limited to, images, pressure, light, touch, force, temperature, position, motion, and so on. For example, the sensor can be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. By further example, the sensor can be a bio-sensor for tracking biometric characteristics, such as health and activity metrics. Other user sensors can perform facial feature detection, facial movement detection, facial recognition, eye tracking, user mood detection, user emotion detection, voice detection, etc. Sensors can include the camera 130 which can capture image based content of the outside world.

The head-mountable device 100 can include a haptic device 194 that provides haptic feedback with tactile sensations to the user. The haptic device 194 can be implemented as any suitable device configured to provide force feedback, vibratory feedback, tactile sensations, and the like. For example, in one embodiment, the haptic device 194 may be implemented as a linear actuator configured to provide a punctuated haptic feedback, such as a tap or a knock.

The head-mountable device 100 can include a battery, which can charge and/or power components of the head-mountable device 100. The battery can also charge and/or power components connected to the head-mountable device 100.

A system 2 including the head-mountable device 100 can further include an electronic device 300. The electronic device 300 can facilitate alignment detection, provide outputs to a user, and/or operate in concert with the head-mountable device 100, as described herein.

The electronic device 300 can include a processor 350 (e.g., control circuitry) with one or more processing units that include or are configured to access a memory having instructions stored thereon. The instructions or computer programs may be configured to perform one or more of the operations or functions described with respect to the electronic device 300. The processor 350 can be implemented as any electronic device capable of processing, receiving, or transmitting data or instructions. For example, the processor 350 may include one or more of: a processor, a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The electronic device 300 can include one or more sensors 310 that are operable to identify, detect, and/or measure multiple regions of the face of a user 10 and/or a head-mountable device, as described herein. For example, the sensors 310 can include a depth sensor, an IMU, and the like.

The electronic device 300 can include a display 340 for displaying visual information for a user. The display 340 can provide visual (e.g., image or video) output. The display 340 may utilize digital light projection, OLEDs, LEDs, uLEDs, liquid crystal on silicon, laser scanning light source, or any combination of these technologies.

The electronic device 300 can include one or more cameras 330. The cameras 330 can capture a view of the head-mountable device 100 and/or a user. The view captured by the camera 330 can be presented by the display 340 or otherwise analyzed to provide a basis for an output on the display 340.

The electronic device 300 can include a communication interface 392 for communicating with one or more servers or other devices using any suitable communications protocol. For example, communication interface 392 can support Wi-Fi (e.g., a 802.11 protocol), Ethernet, Bluetooth, high frequency systems (e.g., 1400 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. A communication interface 392 can also include an antenna for transmitting and receiving electromagnetic signals.

Accordingly, embodiments of the present disclosure provide a head-mountable device with interface features to provide guidance for optimal placement of a head-mountable device. The head-mountable device and/or another electronic device can be operated to guide a user to position the head-mountable device in a manner that will achieve proper alignment of components with respect to the user and maximize user comfort. For example, the head-mountable device and/or another device can include sensors for detecting features of the user's face, forces distributed on the face when worn, and/or alignment with the face (e.g., eyes). The guidance can include instructions or other interface features to encourage adjustment of the head-mountable device. While the head-mountable device can provide such guidance to the user wearing it, the feedback can also be provided to another person and/or via another device.

Various examples of aspects of the disclosure are described below as clauses for convenience. These are provided as examples, and do not limit the subject technology.

Clause A: a head-mountable device comprising: a camera configured to capture an image; a display configured to display the image captured by the camera; a sensor configured to detect a current alignment of the head-mountable device with respect to a face of a user; and a processor configured to: compare the current alignment with a target alignment of the head-mountable device with respect to the face of the user; and when the current alignment does not match the target alignment, remove a portion of the image, the portion being selected based on a difference between the current alignment and the target alignment.

Clause B: a head-mountable device comprising: a camera on an outer side of the head-mountable device and configured to capture a view; a first display on an inner side of the head-mountable device and configured to show the view; a second display on the outer side of the head-mountable device; a sensor configured to detect a current alignment of the head-mountable device with respect to a face of a user; and a processor configured to: compare the current alignment with a target alignment of the head-mountable device with respect to the face of the user; and when the current alignment does not match the target alignment, operate the second display to provide an indicator based on the current alignment and the target alignment.

Clause C: an electronic device comprising: a communication interface configured to receive, from a head-mountable device, a signal based on a current alignment of the head-mountable device with respect to a face of a user; an output interface; and a processor configured to, when the current alignment does not match a target alignment of the head-mountable device with respect to the face of the user, operate the output interface to provide an indicator based on the current alignment and the target alignment.

One or more of the above clauses can include one or more of the features described below. It is noted that any of the following clauses may be combined in any combination with each other, and placed into a respective independent clause, e.g., clause A, B, or C.

Clause 1: the portion of the image is on a side of the display that corresponds to a direction in which the head-mountable device is to move to change from the current alignment to the target alignment.

Clause 2: the processor is further configured to operate the display to shift a visual feature provided on the display based on a difference between the current alignment and the target alignment.

Clause 3: a light seal for engaging the face of the user, wherein the sensor is a force sensor configured to detect a current force between the light seal and the face of the user.

Clause 4: the processor is further configured to determine the current alignment based on whether the current force between the light seal and the face of the user exceeds a threshold.

Clause 5: a light seal for engaging the face of the user, wherein the sensor is a first force sensor configured to detect a first force between the light seal and a first region of the face of the user; and a second force sensor configured to detect a second force between the light seal and a second region of the face of the user; the processor is further configured to determine the current alignment based on whether the first force and the second force are different.

Clause 6: a head engager configured to secure the head-mountable device to a head of the user; a head engagement sensor configured to detect a current tension in the head engager.

Clause 7: the processor is further configured to: compare the current tension with a target tension; and when the current tension does not match the target tension, provide an additional output to the user, the additional output comprising an indication to adjust the head engager.

Clause 8: the sensor is an eye sensor.

Clause 9: the indicator corresponds to a direction in which the head-mountable device is to move to change from the current alignment to the target alignment.

Clause 10: a sensor configured to detect the head-mountable device and the user, wherein the processor is configured to determine the current alignment based on the signal and a detection of the sensor.

Clause 11: the sensor comprises a camera configured to detect fiducial markers of the head-mountable device.

Clause 12: the sensor comprises a depth sensor.

Clause 13: the output interface is a display providing a user interface, wherein the indicator corresponds to a direction in which the head-mountable device is to move to change from the current alignment to the target alignment.

As described herein, aspects of the present technology can include the gathering and use of data. The present disclosure contemplates that in some instances, gathered data can include personal information or other data that uniquely identifies or can be used to locate or contact a specific person. The present disclosure contemplates that the entities responsible for the collection, analysis, disclosure, transfer, storage, or other use of such personal information or other data will comply with well-established privacy practices and/or privacy policies. The present disclosure also contemplates embodiments in which users can selectively block the use of or access to personal information or other data (e.g., managed to minimize risks of unintentional or unauthorized access or use).

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A head-mountable device comprising:
a camera configured to capture an image;
a display configured to display the image captured by the camera;
a sensor configured to detect a current alignment of the head-mountable device with respect to a face; and
a processor configured to:
compare the current alignment with a target alignment of the head-mountable device with respect to the face to determine a portion of the image to be removed from the display; and
when the current alignment does not match the target alignment, remove the portion of the image from the display.

2. The head-mountable device of claim 1, wherein the portion of the image is on a side of the display that corresponds to a direction in which the head-mountable device is to move to change from the current alignment to the target alignment.

3. The head-mountable device of claim 1, wherein the processor is further configured to operate the display to shift a visual feature provided on the display based on a difference between the current alignment and the target alignment.

4. The head-mountable device of claim 1, further comprising a light seal for engaging the face, wherein the sensor is a force sensor configured to detect a current force between the light seal and the face.

5. The head-mountable device of claim 4, wherein the processor is further configured to determine the current alignment based on whether the current force between the light seal and the face exceeds a threshold.

6. The head-mountable device of claim 1, further comprising:
a light seal for engaging the face, wherein the sensor is a first force sensor configured to detect a first force between the light seal and a first region of the face; and
a second force sensor configured to detect a second force between the light seal and a second region of the face.

7. The head-mountable device of claim 6, wherein the processor is further configured to determine the current alignment based on whether the first force and the second force are different.

8. The head-mountable device of claim 1, further comprising:
a head engager configured to secure the head-mountable device to a head; and
a head engagement sensor configured to detect a current tension in the head engager.

9. The head-mountable device of claim 8, wherein the processor is further configured to:
compare the current tension with a target tension; and
when the current tension does not match the target tension, provide an additional output, the additional output comprising an indication to adjust the head engager.

10. The head-mountable device of claim 1, wherein the sensor is an eye sensor.

11. A head-mountable device comprising:
a first display on an inner side of the head-mountable device;
a second display on an outer side of the head-mountable device;
a sensor configured to detect a current alignment of the head-mountable device with respect to a face; and
a processor configured to:
compare the current alignment with a target alignment of the head-mountable device with respect to the face; and
when the current alignment does not match the target alignment, operate the second display to provide an indicator based on the current alignment and the target alignment.

12. The head-mountable device of claim 11, wherein the indicator corresponds to a direction in which the head-mountable device is to move to change from the current alignment to the target alignment.

13. The head-mountable device of claim 11, further comprising a light seal for engaging the face, wherein the sensor is a force sensor configured to detect a current force between the light seal and the face.

14. The head-mountable device of claim 13, wherein the processor is further configured to determine the current alignment based on whether the current force between the light seal and the face exceeds a threshold.

15. The head-mountable device of claim 11, wherein the sensor is an eye sensor.

16. An electronic device comprising:
a communication interface configured to receive, from a head-mountable device, a signal based on a current alignment of the head-mountable device with respect to a face;
an output interface; and
a processor configured to, when the current alignment does not match a target alignment of the head-mountable device with respect to the face, operate the output interface to provide an indicator based on the current alignment and the target alignment.

17. The electronic device of claim 16, further comprising a sensor configured to detect the head-mountable device and the face, wherein the processor is configured to determine the current alignment based on the signal and a detection of the sensor.

18. The electronic device of claim 17, wherein the sensor comprises a camera configured to detect fiducial markers of the head-mountable device.

19. The electronic device of claim 17, wherein the sensor comprises a depth sensor.

20. The electronic device of claim 16, wherein the output interface is a display providing a user interface, wherein the indicator corresponds to a direction in which the head-mountable device is to move to change from the current alignment to the target alignment.
